(19) United States
(12) Patent Application Publication
(10) Pub. No.: US 2013/0127756 A1
(43) Pub. Date: May 23, 2013

(54) Noise Filtering Method

(71) Applicant: NOVATEK Microelectronics Corp., Hsin-Chu (TW)

(72) Inventors: Shun-Li Wang, Hsinchu City (TW); Chun-Chieh Chang, Hsinchu City (TW); Chih-Chang Lai, Taichung City (TW)

(73) Assignee: NOVATEK Microelectronics Corp., Hsin-Chu (TW)

(21) Appl. No.: 13/682,701

(22) Filed: Nov. 20, 2012

(30) Foreign Application Priority Data
Nov. 21, 2011 (TW) 100142514

(51) Int. Cl. G06F 3/0488

(52) U.S. Cl. CPC G06F 3/0488
USPC 345/173

(57) ABSTRACT

The present invention discloses a noise filtering method for a touch control display device. The noise filter method includes retrieving a plurality of touch signals, wherein the plurality of touch signals correspond to a plurality of touch points of the touch control display device, selecting a plurality of environmental sensing signals from the plurality of the touch signals according to a touch threshold value, calculating a peak-to-peak value of the plurality of the environmental sensing signals, comparing the peak-to-peak value with a noise threshold value to generate a comparison result, and determining a filtering coefficient according to the comparison result in order to perform a noise filtering procedure accordingly.

### BACKGROUND OF THE INVENTION

1. Field of the Invention

The present invention relates to a noise filtering method, and more particularly, to a noise filtering method for dynamically detecting environmental noise.

2. Description of the Prior Art

Due to more intuitive and convenient operation, a touch control display device has been widely adopted among electrical products. Generally, the touch control display device includes a display panel and a transparent touch panel. Through attachment of the transparent touch panel onto the display panel, the touch control display device can realize touch control functions as well as display functions. Currently, capacitive touch control is the most popular.

Capacitive touch control techniques detect sensing capacitance changes generated by static electricity recombination as human beings or objects touch the touch panel, so as to determine a touch event. Please refer to FIG. 1, which illustrates a schematic diagram of a conventional capacitive touch control panel 10. The conventional capacitive touch control panel 10 includes a plurality of sensing capacitor series X₁-Xₘ and Y₁-Yₙ disposed on a substrate 102, where each sensing capacitor series includes a plurality of serial sensing capacitors. As shown in FIG. 1, each of the plurality of serial sensing capacitors is a one-dimensional rhombus shape with size ranging from 4 millimeters to 7 millimeters. In this configuration, the prior art utilizes interpolation to calculate a coordinate position of a touch point in order to achieve precise position. For example, if the size of the sensing capacitors is 6 millimeters, a spatial resolution can be 50 micrometers. The interpolation and its related calculation are known by those skilled in the art, and are not described hereinafter. However, the coordinate positions calculated by the interpolation can be easily affected by noise. Fluctuation of the coordinate positions occurs over time. In the prior art, one solution to the above problems is to provide digital low-pass filters installed within sensing areas of the touch points to filter the noise of the sensing areas, so as to alleviate the fluctuation effect at the coordinate positions.

Generally, the digital low-pass filter is realized by an Infinite Impulse Response (IIR) filter, and a filtering coefficient of the digital low-pass filter is selected as a constant. In order to reduce a response period and prevent users from experiencing a sense of delay, two cycles of input signals are utilized to generate an output signal. The equation of a first-order IIR filter is represented as following:

y[n]=(1−α)·y[n−1]+α·x[n] (1)

In equation (1), x[n] represents the input signals of the filter, y[n]represents the output signals of the filter, and α is a coefficient of the filter with range from 0 to 1. For practical applications, the coefficient α is generally preset as a power of 2, such as ¼, ½, and ¾, etc. In detail, a present output signal can be determined according to a present input signal and a previous output signal, and it is not necessary to utilize a large amount of memory space for realizing a noise filtering procedure.

Furthermore, efficiency of the IIR filter is determined by the coefficient α. When the coefficient α is smaller, an output curve of an output result (i.e. the output signal) will be more smooth and stable. However, under such circumstances, a longer response period is needed to restore the output signal to a stable state once the present input signal is apparently different from the previous input signal. Similarly, when the coefficient α is larger, a shorter response period is needed to restore the output signal to the stable state. Under such circumstances, if strong noise exists within the input signal, the output curve of the output result will be interfered with by the noise, and will exhibit more fluctuation and be unstable. In other words, when the coefficient is smaller, the IIR filter has a stronger filtering effect with better noise elimination ability; when the coefficient is larger, the IIR filter has weaker filtering effect with poorer noise elimination ability. Please refer to FIG. 2, which illustrates a schematic diagram of the output result of the IIR filter according to different coefficients α versus the same input signal, wherein the X-axis represents a time and the Y-axis represents a signal intensity. As shown in FIG. 2, under the condition that the coefficient α is 1, the output signal equals the input signal, which means that there is currently no filtering effect. Under the condition that the coefficient α is ¼, the output curve of the output result will be smooth and stable due to the stronger filtering effect. Certainly, the corresponding response period will be longer and cause delay of the output result. Under the condition that the coefficient α is ½, the filtering effect will be worse and have a shorter response period in comparison with the coefficient α being ¼. Although the IIR filter can respond to the input signal in a timely manner under the condition that the coefficient α is ½, the poor noise elimination ability can be anticipated in comparison with the coefficient α being ¼.

In practice, the coefficient of the digital low-pass filter is usually fixed as a constant. Thus, using the smaller coefficient provides the better noise elimination ability accompanying the longer response period, even though there is less noise in the input signal. On the other hand, using the larger coefficient provides the shorter response period accompanying poor noise elimination ability for the noise filtering procedure. Since sensing signals sensed by the touch points may have different levels of noise, using only one fixed coefficient for the noise filtering procedure can lead to poor estimation of the touch points, and lead to an unnecessarily long response period.

### SUMMARY OF THE INVENTION

It is therefore an objective of the present invention to provide a noise filtering method.

A noise filtering method for a touch control display device includes retrieving a plurality of touch signals, wherein the plurality of touch signals correspond to a plurality of touch points of the touch control display device, selecting a plurality of environmental sensing signals from the plurality of the touch signals according to a touch threshold value, calculating a peak-to-peak value of the plurality of the environmental sensing signals, comparing the peak-to-peak value with a noise threshold value to generate a comparison result, and determining a filtering coefficient according to the comparison result in order to perform a noise filtering procedure accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional capacitive touch control panel.

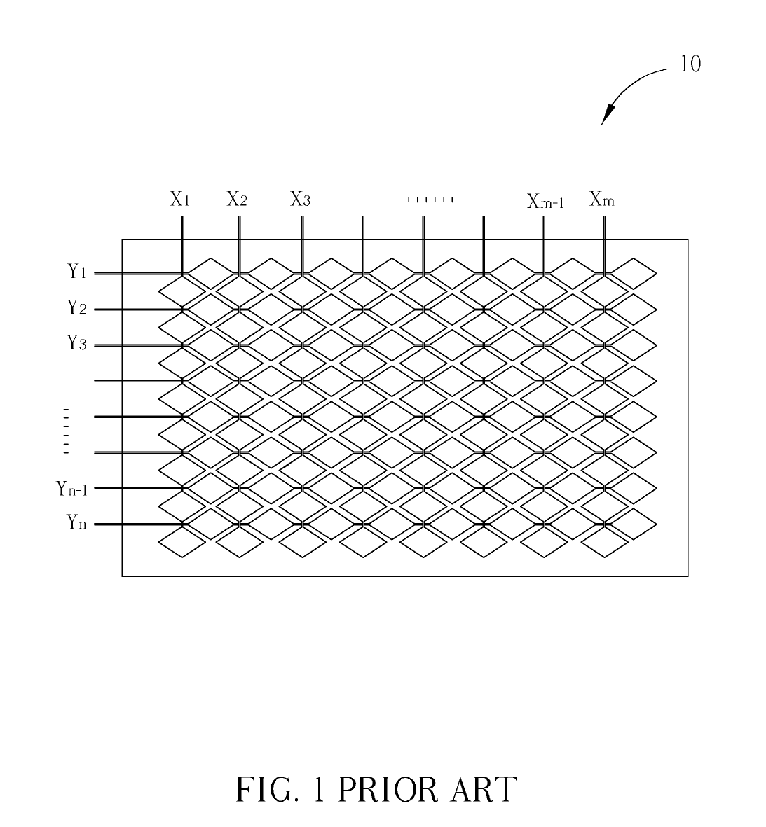

FIG. 2 illustrates a schematic diagram of the output result of the IIR filter according to different coefficients a versus the same input signal.

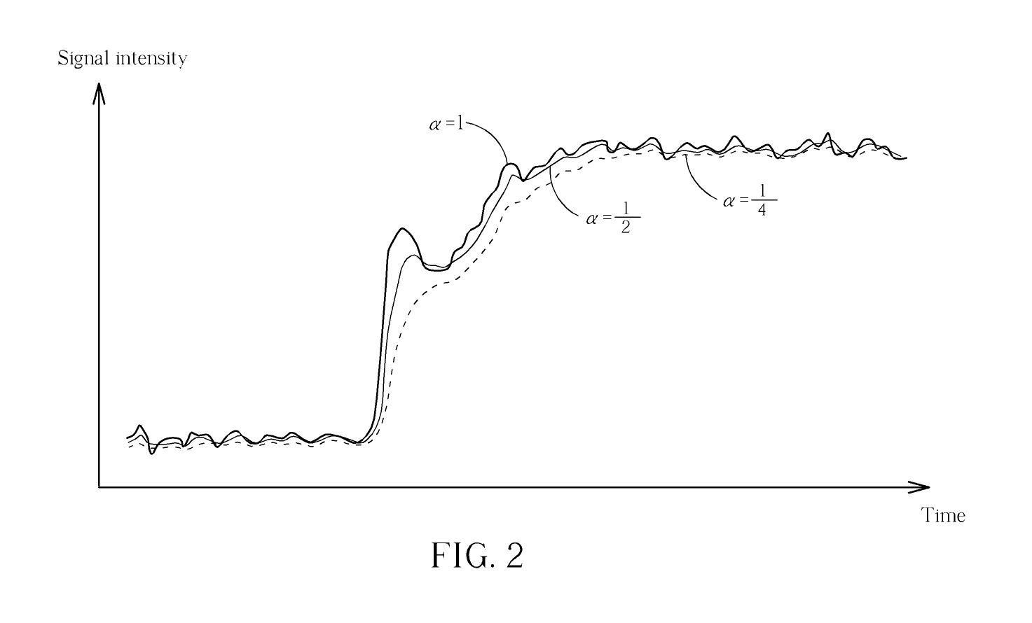

FIG. 3 illustrates a flow chart of a noise filtering process according to the present invention.

FIG. 4 illustrates another flow chat of a noise filtering process according to the present invention.

FIG. 5 illustrates a distribution diagram of a touch sensing signals in a low-level-noise environment.

FIG. 6 illustrates a distribution diagram of a touch sensing signals in a high-level-noise environment.

### DETAILED DESCRIPTION

The present invention discloses a noise filtering method for all kinds of capacitive touch control display devices. The noise filtering method of the present invention can be combined arbitrarily with any capacitive touch control display device and operate functionally with an Infinite Impulse Response (IIR) filter as disclosed in the prior art, which is not described hereinafter. In comparison with the prior art, the present invention provides the noise filtering method to dynamically adjust a filtering coefficient of the IIR filter, to increase accuracy of calculating a coordinate position of a touch point, and to alleviate a fluctuation of the coordinate position of the touch point as time passes in order to shorten an unnecessary response period.

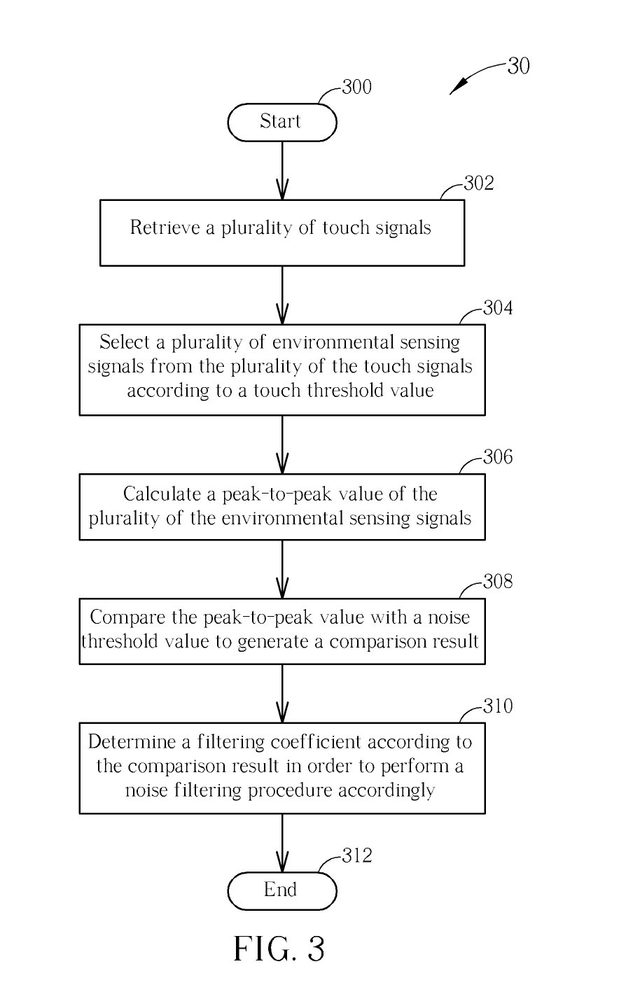

The noise filtering method for a touch control display device of the present invention can be summarized as a noise filtering process 30, where the touch control display device includes a plurality of touch points, as shown in FIG. 3. The noise filtering process 30 includes the following steps:

Step 300: Start.

Step 302: Retrieve a plurality of touch signals.

Step 304: Select a plurality of environmental sensing signals from the plurality of the touch signals according to a touch threshold value.

Step 306: Calculate a peak-to-peak value of the plurality of the environmental sensing signals.

Step 308: Compare the peak-to-peak value with a noise threshold value to generate a comparison result.

Step 310: Determine a filtering coefficient according to the comparison result in order to perform a noise filtering procedure accordingly.

Step 312: End.

According to the noise filtering process 30, in the step 302, the plurality of touch signals corresponding to the plurality of touch points of the touch control display device are retrieved. Supposed that the touch control display device includes the plurality of touch points, and each of the touch points has a corresponding sensing capacitor. Through sensing the capacitance changes of those sensing capacitors, the corresponding touch signals are generated. Ways of retrieving the sensing signals can be realized in different embodiments, and are not limited hereinafter. In this embodiment, a sensing device can be installed to sense the capacitance changes of the sensing capacitor, so as to generate a corresponding analog touch signal. Via an analog-to-digital converter, the analog touch signal can be converted into the touch signal. Noticeably, in the step 302, it can be designed to retrieve either all or part of the sensing signals corresponding to the touch points of the touch control display device. Users can predetermine a number or particular zones of the touch points if only parts of the sensing signals corresponding to the touch points are retrieved. Preferably, each sensing signal can be retrieved simultaneously to respond a real-time touch point situation.

Next, in the step 304, the plurality of environmental sensing signals are selected from the plurality of touch signals according to the touch threshold value. In other words, the environmental sensing signals are determined according to the touch threshold value, which indicates whether a touch event happens or not. Generally, if the touch event happens, the capacitance changes of the sensing capacitor of the touch point can be dramatically huge. On the contrary, if nobody touches the touch points, the capacitance changes of the sensing capacitor of the touch point can be small, which are caused due to some environmental factors (i.e. noise) or material defects of the capacitor. Therefore, via presetting the touch threshold value, users can tell whether the touch event happens on not. For example, if the threshold value when no touch events occur is less than 20, users can preset the touch threshold value to be 20 in the step 304, so as to determine whether the touch points have been touched or not.

Furthermore, in the step 304, users compare the retrieved sensing signals with the touch threshold value to determine whether the touch event actually happens or not. For example, if the touch signals are smaller than the touch threshold value, these touch signals are regarded as the environmental sensing signals, which simply means the capacitance changes are caused by some environmental factors or material defects of the capacitor. The other touch points with corresponding touch signals larger than the touch threshold value are excluded, in which those touch points being actually touched are excluded and are not considered for the following calculation procedure.

In the step 306, the peak-to peak value is calculated from the selected environmental sensing signals, in which the peak-to-peak value indicates the difference between max and min of the environmental sensing signals. Therefore, via calculating differences of max and min of the environmental sensing signals, a real situation of the environmental sensing signals can be shown from the peak-to-peak value. For example, when the peak-to-peak value is small, it means that all touch points are in the similar situation. When the peak-to-peak value is large, it means that some touch points are suffering serious environmental noise and have different levels of sensing signals.

In the step 308, the comparison result is generated according to the peak-to-peak value and the noise threshold value. Last, in the step 310, the filtering coefficient is determined according to the comparison result, to select the appropriate filtering coefficient of the IIR filter, so as to continue the noise filtering procedure for the touch points of the touch control display device.

When the comparison result in the step 308 shows that the peak-to-peak value is larger than the noise threshold value, it means that there exists large environmental noise, or that a power supply system supplies a poor input signal with large noise. Therefore, the first coefficient is selected to be the filtering coefficient of the IIR filter for continuing the noise filtering procedure. The first coefficient is smaller than the filtering coefficient currently utilized, and corresponds to a strong low-pass filter. In other words, when the peak-to-peak value is larger than the noise threshold value, it means the current environment has high noise. Thus, the strong low-pass filter with a better filtering ability is utilized for the noise filtering procedure.

Similarly, when the comparison result in the step 308 shows that the peak-to-peak value is smaller than the noise threshold value, it means that lower environment noise exists. Therefore, the second coefficient is selected to be the filtering coefficient of the IIR filter for continuing the noise filtering procedure. The second coefficient is larger than the filtering coefficient currently utilized, and corresponds to a weak low-pass filter. In other words, when the peak-to-peak value is smaller than the noise threshold value, it means that the current environment has lower noise, and the weak low-pass filter with a normal filtering ability is utilized for the noise filtering procedure, so as to shorten response period of the IIR filter. In short, the present invention provides the noise filtering method for dynamically adjusting the filtering coefficient according to the environmental conditions to appropriately select the filtering coefficient for the noise filtering procedure.

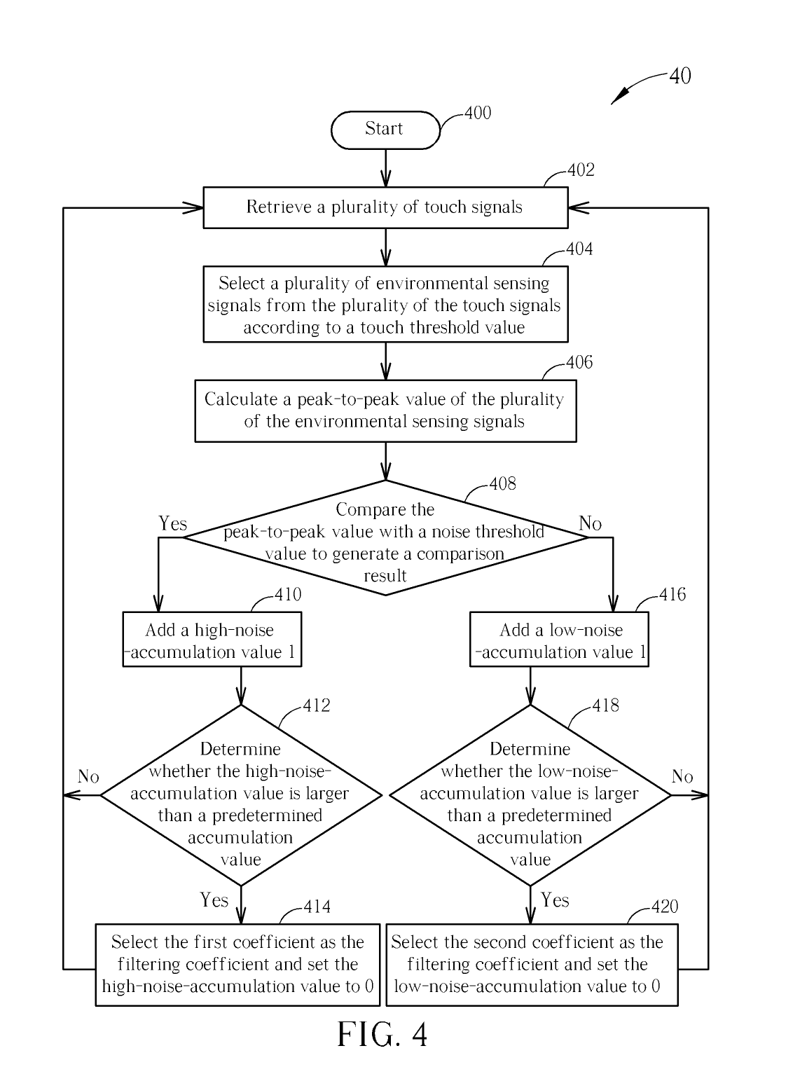

On the other hand, in order to correctly select the appropriate filter, in the step 310, users can accumulate a high-noise-accumulation value or a low-noise-accumulation value according to the comparison result generated by the step 308, so as to determine the filtering coefficient. Users can determine whether the calculating result from the previous step is correct or not via the high-noise-accumulation value or the low-noise-accumulation value. Please refer to FIG. 4, which illustrates another flow chart of the noise filtering process 40 according to the present invention. The step 400 to the step 406 of the noise filtering process 40 are similar to the step 300 to the step 306 of the noise filtering process 30, which are not described hereinafter. In the step 408, the comparison result is generated according to whether the peak-to-peak value is larger than the noise threshold value. When the comparison result indicates that the peak-to-peak value is larger than the noise threshold value, it proceeds to the step 410 and the high-noise-accumulation value adds 1. In the step 412, it determines whether the high-noise-accumulation value is larger than a predetermined accumulation value. If the high-noise-accumulation value is larger than the predetermined accumulation value, it indicates that a better filtering ability of the filter is necessary, and proceeds to the step 416 to select the first coefficient as the filtering coefficient. Thus, a corresponding IIR filter is selected for the noise filtering procedure, and the high-noise-accumulation value is reset to 0 to restart the noise filtering process 40. As mentioned from the above, the selected first coefficient is smaller than the filtering coefficient of the present IIR filter, and the first coefficient corresponds to a strong low-pass filter. Similarly, in the step 408, when the comparison result indicates that the peak-to-peak value is smaller than the noise threshold value, it proceeds to the step 416 and the low-noise-accumulation value adds 1. In the step 418, it determines whether the low-noise-accumulation value is larger than the predetermined accumulation value. If the low-noise-accumulation value is larger than the predetermined accumulation value, a poor filtering ability rather than the better filtering ability of the filter is allowable, and it proceeds to the step 420 to select the second coefficient as the filtering coefficient. A corresponding IIR filter is selected for the noise filtering procedure, and the low-noise-accumulation value is reset to 0 to restart the noise filtering process 40. Noticeably, the selected second coefficient is larger than the filtering coefficient of the present IIR filter, and the second coefficient corresponds to a weak low-pass filter. In addition, in the steps 412 and 418, if the high-noise-accumulation value or the low-noise-accumulation value is smaller than the predetermined accumulation value, the filtering coefficient of the IIR filter will not change, and it restarts from the step 402. Periodical accumulation continues to accumulate the high-noise-accumulation value and low-noise-accumulation, and then adjusts the filtering coefficient while either the high-noise-accumulation value or the low-noise-accumulation is larger than the predetermined accumulation value. As a result, it is certain that the appropriate filter is selected for the noise filtering procedure.

Thus, the noise filtering processes 30 and 40 can exclude those touch points which are actually touched by human beings or objects to select the environmental sensing signals related to the environmental condition and to adjust the filtering coefficient of the IIR filter for the noise filtering procedure accordingly. When the environmental signals are serious and abundant, the better filtering ability of the IIR filter is selected; on the contrary, when the environmental signals are insignificant and minor, the poor filtering ability of the IIR filter is selected. Under those circumstances, the filter can shorten response period for the noise filtering procedure, and users can dynamically select an appropriate filter for the noise filtering procedure according to the environmental conditions.

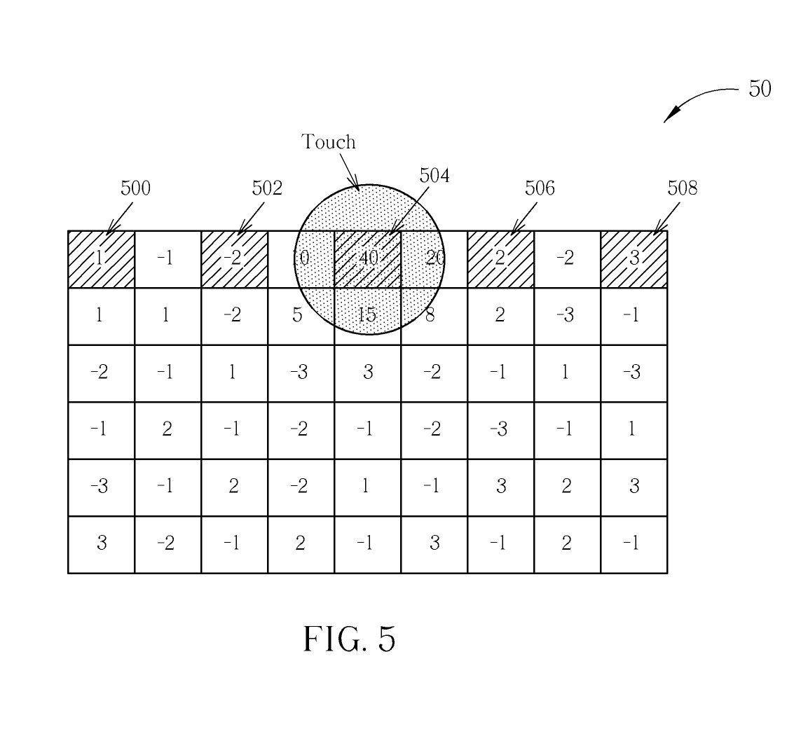

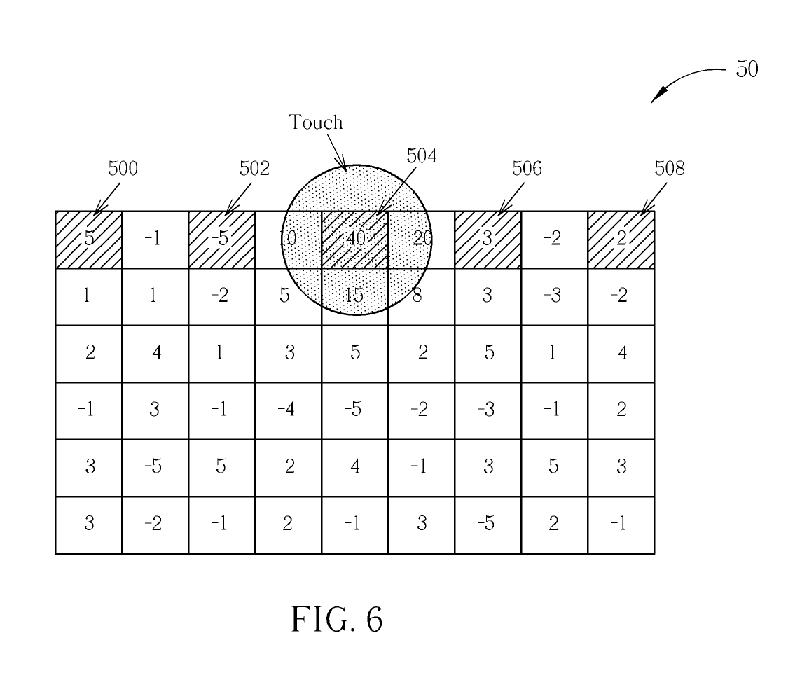

For example, please refer to FIG. 5, which illustrates a distribution diagram of touch sensing signals in a low-level-noise environment. As shown in FIG. 5, the touch panel 50 shows a number of 6×9 zones, each of which equally has a number of 54 touch points. Each zone shows an indicating value which is sensed by each touch point of the touch panel 50 for representing the sensing signals, i.e. those indicating values shown in FIG. 5 represent the capacitance changes sensed by the touch points. The ellipse Touch shown in FIG. 5 indicates a real touch range of a user's finger. First, according to the step 302, five predetermined points 500, 502, 504, 506 and 508 are selected to retrieve the corresponding sensing signals, which are 1, −2, 40, 2 and 3. Suppose that the predetermined touch threshold value is set to 20, and the sensing signals retrieved from the touch points are compared with the touch threshold value. Since the touch point 504 has the sensing value 40, which is larger than the touch threshold value, the sensing signal of the touch point 504 will be excluded from the environmental sensing signal, and the other touch points 500, 502, 506 and 508 are selected to be the environmental sensing signals, which are 1, −2, 2 and 3. Next, the environmental sensing signals are utilized to calculate the peak-to-peak value, and the calculating result will be 3−(−2)=5, i.e. the peak-to-peak value is 5. At this moment, the predetermined noise threshold value 8 is larger than the peak-to-peak value 5, and the low-noise-accumulation value adds 1. Once the low-noise-accumulation value continues to accumulate and becomes larger than the predetermined accumulation value, the low-level-noise environment is determined. A filtering coefficient being larger than the filtering coefficient currently utilized will be selected, to continue the noise filtering procedure. For example, if the filtering coefficient currently utilized by the IIR filter is ½, another filtering coefficient of the IIR filter will be reselected from ½ to ¾. Once environmental noise has dramatically changed, another process will initiate. Please refer to FIG. 6, which illustrates a distribution diagram of touch sensing signals in a high-level-noise environment. The same symbols are utilized in FIG. 6 as in FIG. 5 because they show similar functions and schematic diagrams. As shown in FIG. 6, the predetermined touch points 500, 502, 504, 506 and 508 have the corresponding sensing signals 5, −5, 40, 3 and 2. For the same reason of being larger than the noise threshold value, the touch point 504 is excluded from the environmental sensing signal, and touch points 500, 502, 506 and 508 are selected to be the environmental sensing signals. According to the environmental sensing signals, the peak-to-peak value will be 5−(−5)=10, i.e. the peak-to-peak value is 10. At this moment, the peak-to-peak value 10 is larger than the noise threshold value 8, and the high-noise-accumulation value adds 1. Once the high-noise-accumulation value continues to accumulate and becomes larger than the predetermined accumulation value, a high-level-noise environment is determined. A filtering coefficient smaller than the filtering coefficient currently utilized will be selected to continue the noise filtering procedure. For example, if the filtering coefficient currently utilized by the IIR filter is ½, then another filtering coefficient of the IIR filter will be reselected from ½ to ¼. From the above, the filtering coefficients used are only demonstrative as examples, and will not limit the scope of the present invention.

According to the noise filtering procedure of the present invention, when either the high-noise-accumulation value or the low-noise-accumulation value is larger than the predetermined accumulation value, the filtering coefficient of the IIR filter will be dynamically adjusted to increase estimation accuracy of the coordinate positions, so as to alleviate the fluctuation effect of the coordinate positions while time passes. Thus, those skilled in the art can adjust the present invention to apply to different filters, so as to adjust corresponding filtering coefficients, which are also within the scope of the present invention.

In summary, a noise filtering method of the present invention for the capacitive touch control display device uses a filtering coefficient of a filter that can be dynamically adjusted according to noise detected in the environment. Better estimation accuracy of coordinate positions can be anticipated, and the fluctuation effect of the coordinate positions can be alleviated, so as to shorten a response period of the filter and accelerate the processing period of the filter. In short, the present invention appropriately selects the filter for the noise filtering procedure via dynamically adjusting the filtering coefficient in different environmental conditions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A noise filtering method for a touch control display device, comprising:
retrieving a plurality of touch signals, wherein the plurality of touch signals correspond to a plurality of touch points of the touch control display device;
selecting a plurality of environmental sensing signals from the plurality of the touch signals according to a touch threshold value;
calculating a peak-to-peak value of the plurality of the environmental sensing signals;
comparing the peak-to-peak value with a noise threshold value to generate a comparison result; and
determining a filtering coefficient according to the comparison result in order to perform a noise filtering procedure accordingly.

2. The noise filtering method of claim 1, wherein the step of retrieving the plurality of touch signals comprises:
simultaneously retrieving touch signals sensed by the plurality of touch points of the touch control display device to be the plurality of touch signals.

3. The noise filtering method of claim 1, wherein the step of selecting the plurality of environmental sensing signals from the plurality of touch signals according to the touch threshold value comprises:
comparing the plurality of touch signals with the touch threshold value; and
selecting the plurality of touch signals as the plurality of environmental sensing signals while the plurality of touch signals are smaller than the touch threshold value.

4. The noise filtering method of claim 1, wherein the step of calculating the peak-to-peak value of the plurality of environmental sensing signals comprises:
calculating differences between max and min of the plurality of environmental sensing signals to generate the peak-to-peak value.

5. The noise filtering method of claim 1, wherein the step of determining the filtering coefficient according to the comparison result in order to perform the noise filter procedure accordingly comprises:
calculating a high-noise-accumulation value and a low-noise-accumulation value according to the comparison result; and
determining the filtering coefficient in order to perform the noise filtering procedure according to the high-noise-accumulation value and the low-noise-accumulation value.

6. The noise filtering method of claim 5, wherein the step of calculating the high-noise-accumulation value and the low-noise-accumulation value according to the comparison result comprises:
adding 1 to the high-noise-accumulation value while the comparison result indicates that the peak-to-peak value is larger than the noise threshold value.

7. The noise filtering method of claim 6, wherein the step of determining the filtering coefficient in order to perform the noise filtering procedure according to the high-noise-accumulation value and the low-noise-accumulation value comprises:
selecting a first coefficient for the noise filtering procedure while the high-noise-accumulation value is larger than a predetermined accumulation value, wherein the first coefficient is smaller than a filtering coefficient currently utilized.

8. The noise filtering method of claim 7, wherein the first coefficient corresponds to a strong low-pass filter.

9. The noise filtering method of claim 5, wherein the step of calculating the high-noise-accumulation value and the low-noise-accumulation value according to the comparison result comprises:
adding 1 to the low-noise-accumulation value while the comparison result indicates that the peak-to-peak value is smaller than the noise threshold value.

10. The noise filtering method of claim 9, wherein the step of determining the filtering coefficient in order to perform the noise filtering procedure according to the high-noise-accumulation value and the low-noise-accumulation value comprises:
selecting a second coefficient for the noise filtering procedure while the low-noise-accumulation value is larger than the predetermined accumulation value, wherein the second coefficient is larger than a filtering coefficient currently utilized.

11. The noise filtering method of claim 10, wherein the second coefficient corresponds to a weak low-pass filter.

12. The noise filtering method of claim 1, wherein the step of determining the filtering coefficient according to the comparison result in order to perform the noise filtering procedure accordingly comprises:
selecting a first coefficient for the noise filtering procedure while the comparison result indicates that the peak-to-peak value is larger than the noise threshold value, wherein the first coefficient is smaller than a filtering coefficient currently utilized and the first coefficient corresponds to a strong low-pass filter.

13. The noise filtering method of claim 1, wherein the step of determining the filtering coefficient according to the comparison result in order to perform the noise filtering procedure accordingly comprises:
selecting a second coefficient for the noise filtering procedure while the comparison result indicates that the peak-to-peak value is smaller than the noise threshold value, wherein the second coefficient is larger than a filtering coefficient currently utilized and the second coefficient corresponds to a weak low-pass filter.

14. The noise filtering method of claim 1, wherein the filtering coefficient is a filtering coefficient of an Infinite Impulse Response Filter.
